(19) United States
(12) Patent Application Publication
(10) Pub. No.: US 2002/0065764 A1
(43) Pub. Date: May 30, 2002

(54) Marketing and purchasing components and services

(76) Inventors: Andrew N. Brodersen JR., Coventry, CT (US); Wendy L. Crate, North Granby, CT (US)

Correspondence Address: George J. Romanik, Pratt & Whitney, MS 132-13, 400 Main Street, East Hartford, CT, 06108, US

(21) Appl. No.: 09/903,203

(22) Filed: Jul. 11, 2001

Related U.S. Application Data
(63) Continuation-in-part of application No. 09/446,262, filed on May 5, 2000.

(51) Int. Cl. G06F 17/60

(52) U.S. Cl. 705/37

(57) ABSTRACT

A computerized method for marketing components or services includes receiving a request for a requested component or service from a customer and determining whether the requested component or service is available to be provided to the customer. If the requested component or service is available to be provided to the customer, the requested component or service is offered to the customer. If the requested component or service is not available to be provided to the customer, a reverse auction for the requested component or service is conducted among a plurality of suppliers. The requested component may be a life-limited component, such as a life-limited aircraft engine component.

This is a continuation-in-part of co-pending application number 09/446,262, which was filed on Dec. 17, 1999.

### TECHNICAL FIELD

This invention relates to a method and system for marketing and purchasing components and services. More particularly, this invention relates to a computerized method and system that has particular utility in the purchase of aircraft parts and aircraft-related services in a web-based environment.

### BACKROUND OF THE INVENTION

Both new and used parts and various services are used in the operation, maintenance, and overhaul of aircraft. Purchasers of parts and services are typically aircraft owners or operators and facilities that perform aircraft and aircraft engine maintenance and overhaul. The purchase and sale of parts and services can be an arduous endeavor for the customers involving multiple suppliers. These purchasers often have to procure parts in a somewhat convoluted manner dependent upon advice or requirements provided by the original equipment manufacturer (OEM), Federal Aviation Administration (FAA), other civil airworthiness authority, and/or the current owner of the required new or used part. New parts are generally purchased from the OEM or it's distributors. Used parts may be purchased from a variety of sources including brokers who have obtained various inventories and then offer parts for resale. Often parts have undergone inspections and repair to prepare them for immediate use and to create a more saleable inventory. Prices for used parts are often based on what the market will bear and prices for urgently needed parts are inflated due to the urgency. Prices are often further inflated due to broker-to-broker trading.

Used parts inventory availability may be published on part and inventory location services, but the customer must contact the inventory owner directly for pricing and order placement. When the part is not available from the first supplier, the customer must continue contacting additional suppliers until they are able to satisfy the requirement. Since new and used parts are supplied from different suppliers, the customer is usually required to deal with multiple suppliers rather than a single source. Overall, there is little opportunity for significant so-called “one-stop” shopping in aircraft parts. The procurement process is further complicated by the need for the customer to review technical data (i.e. part trace and FAA forms) on used parts.

The purchase and sale of used aircraft engine parts may be complicated when the parts are cycle limited. Life limited or cycle limited parts are difficult to price from a comparison standpoint and in a reverse auction situation determining the winning price and supplier may reveal information competitors do not wish to share with other, such as the state and cycles remaining on parts in their inventory.

It would be desirable to provide a single source for new and used parts that offers a high expectation of meeting part procurement requirements in an efficient manner.

### SUMMARY OF THE INVENTION

The present invention provides a single source for new and used parts that offers a high expectation of meeting part procurement requirements in an efficient manner.

One aspect of the present invention includes a computerized method for marketing components or services that includes receiving a request for a requested component or service from a customer with criteria information for the component or service and determining whether the requested component or service is available to be provided to the customer. If the requested component or service is available to be provided to the customer, the requested component or service is offered to the customer. If the requested component or service is not available to be provided to the customer, a reverse auction for the requested component or service is conducted among a plurality of suppliers. The reverse auction is conducted by receiving bids from two or more suppliers that offer to sell an offered component or service in response to the request for the requested component or service and comparing criteria information for each offered component or service with criteria information for the requested component or service to determine if the offered component or service approximately meets criteria information for the requested component or service. If one or more offered component or service approximately meets criteria information for the requested component or service, one of the offered components or services is selected to offer to the customer and is offered to the customer.

In another aspect of the present invention the reverse auction is conducted by notifying a plurality of suppliers of a desire to purchase a requested component or service and a target bid for the requested component or service. A first supplier bid to sell an offered component or service in response to the request for the requested component or service is received and reviewed. If the first supplier bid is lower than the target bid, the first supplier bid is established as the lowest bid. An additional suppler bid to sell another offered component or service may be received and reviewed. If the additional supplier bid is lower than the lowest bid, the lowest bid is updated to equal the additional supplier bid and the supplier that made the previous lowest bid is notified of the new lowest bid. If the additional supplier bid is higher than the lowest bid but lower than another supplier bid previously received, the supplier that made the supplier bid that is immediately higher than the additional supplier bid is notified of the additional supplier bid. These steps are repeated until there are no additional supplier bids to review.

In another aspect of the present invention a computerized method for marketing life-limited components includes receiving a request for a requested life-limited component from a customer with criteria information for the component, including a minimum number of life units remaining on the component and searching component inventory information to determine whether the requested component is available from an inventory. If the requested component is available from an inventory, the requested component is offered to the customer. If the requested component is not available from an inventory, a reverse auction for the requested component is conducted among a plurality of suppliers.

Another aspect of the present invention includes a computerized method for marketing used, life-limited aircraft engine components for execution on a web-based system with Internet connections to customers and suppliers. The method includes receiving from a customer a request for a requested used, life-limited aircraft engine component having identified requirements of overhaul condition, trace information, and minimum number of life units remaining on the component and conducting a reverse auction for the requested component among a plurality of suppliers. The reverse auction is conducted by notifying the plurality of suppliers of a request for the requested component with the identified requirements and receiving a plurality of bids for a proposed sale of a bid component from suppliers with criteria information of overhaul condition, trace information, number of life units remaining on the component. Based on the bids received, it is determined whether to offer a bid component for sale to the customer. The customer is notified of availability of a bid component.

Another aspect of the present invention includes a sequence of computer data signals in executing a computerized method for marketing life-limited components. A first data signal embodied in a transmission medium from a customer to a primary supplier identifies a requested component with identified criteria, including a minimum number of life units remaining on the component. A second data signal embodied in a transmission medium from a primary supplier to a plurality of secondary suppliers identifies the requested component with the identified criteria in the first data signal. A third data signal embodied in a transmission medium from one of the plurality of secondary suppliers to the primary supplier identifies a bid for a proposed sale of a bid component with component criteria and is responsive to the requested component in second data signal.

### BRIEF DESCRIPTION OF THE DRAWINGS

FIG. 1 is a flowchart of steps performed in a computerized method of the present invention for marketing aircraft components;

FIG. 2 which includes FIGS. 2A and 2B are flowcharts of steps performed in a reverse auction process of the type of FIG. 1.

FIG. 3 is a data flowchart of a selected sequence from an alternate embodiment of the method of FIG. 1 including a reverse auction;

FIG. 4 which includes FIGS. 4A-4D are graphical user interfaces for the sequence of FIG. 3;

FIG. 5 is a block diagram of a general purpose computer of the type for executing the computerized method of the present invention.

### BEST MODE FOR CARRYING OUT THE INVENTION

Although the present invention has particular utility in purchasing aircraft parts and is described in the specific context of purchasing aircraft engine parts, one skilled in the art will understand that the present invention may be used to purchase other aircraft parts, aircraft-related services, and other types of components, items, and services. The specific configurations of the present invention selected for illustration in the drawings and following description are not intended to limit the scope of the invention, which is defined in the appended claims.

In the purchase and sale of aircraft engine parts, particularly used parts, various nomenclature is generally used and accepted by the industry to identify the status of the part and is used for purposes of describing the present invention. For example, a “serviceable part” is a part that has come off an engine and can go back in service on an engine without repair. An “overhauled part” is a used part that has been overhauled to meet certain inspection criteria for overhauled parts as stated in an approved overhaul manual. Unless it is a life-limited part, the service time for an overhauled part is effectively treated as if the part were new. An “overhaulable part” is a used part that has the ability to be overhauled. A “repaired part” is a used part that has been repaired to meet certain inspection criteria for repaired parts. A “repairable part” is a used part that needs to be repaired to be serviceable. Generally, an overhaul procedure is more comprehensive than a repair procedure. A repaired part may not meet all overhaul criteria according to the applicable overhaul manual but it may be acceptable to re-enter service according to the standards of the engine operator or airlines. Typically a used part is accompanied by a maintenance release document, on a form provided by the relevant civil airworthiness authority, that identifies the status of the part, i.e., serviceable, overhauled, repaired, etc. Two common maintenance release documents are the FAA's form 8130-3 and the Joint Airworthiness Authorities' Form-1.

In a typical transaction, the supplier receives a part request from a customer. The customer may be seeking a new part, a used part or a used part if a new part is not available. Customer procurement decisions are made based upon such considerations as cost (i.e., new part cost versus used part cost), life requirements and expectancy of the part, availability, and the urgency with which the part is needed.

In seeking a part, the customer may specify certain requirements or criteria for the part such as times/cycles remaining, overhaul condition, trace, overhauler, etc. Criteria specifying “times/cycles” relates to life-limited parts. Rotating parts such as a disk, hub or shaft are time-limited parts and cycle-limited parts. For example, the average disk may be limited to 30,000 hours of operation and 15,000 cycles so as the hours and cycles are expended, the value of the part may decrease. Therefore, there may be times/cycles requirements based upon how the customer intends to use the part, e.g., how long it will fly, the conditions of use, etc.

The criteria of overhaul condition refers to the status of the part, e.g., the customer may insist that the part be overhauled or repaired, etc. The “overhauler” is the entity that certifies the overhaul on the maintenance release document and the customer might only want to accept overhauled parts from certain overhaul facilities such as Pratt & Whitney. Therefore, the overhauler entity may be a requirement for the part.

“Trace” is a significant criteria and relates to the ability to trace (and document) the part back in time, e.g., to the last owner/operator of the part or a complete history of the part back to the OEM. Since multiple brokers could be involved with a part, the customer typically wants to know the last owner, the last operator, and the specific engine from which the part was removed. The customer may also require a certification from the owner that the part was purchased from an OEM and that the part was not subject to stress such as that caused by accident or fire. Parts that are not manufactured by an OEM are referred to as “PMA parts.” “PMA” is an abbreviation for Parts Manufacturing Authority which is authorization by the FAA for a manufacturer to manufacture certain parts. If a part is a PMA part, the customer typically would want that information.

Upon receiving the customer's request for a part with specified criteria, the supplier searches its new parts and/or used parts inventories for the requested part. Available parts that do not meet all the customer's criteria may nevertheless be offered to the customer thereby necessitating varying degrees of data review by the customer.

Prior to the present invention, if the supplier was unable to meet the customer's requirements from its inventories, the customer had to continue contacting additional suppliers until it is able to satisfy its requirements. The process is further complicated and encumbered by the need of the customer to review technical data and documentation on proposed used parts (e.g., part trace data and documentation, maintenance release documents, etc.) in evaluating the proposed parts from each supplier. In the sale of used engine parts, the associated documentation is important and the quality of the documentation very often accounts for the market value of the part.

In the present business method, one-stop shopping is provided with a high probability of satisfying requirements in an efficient, convenient manner. The present method is preferably implemented in software and embodied in an online web-based system for the marketing of new and used parts or services. The customer's part request including part criteria is received electronically via the Internet (or other link) by the primary supplier such as an OEM or other maintenance organization. The request may be for a single part, a plurality of the same part number, a mixed lot of various part numbers, or any other conceivable combination of parts a customer may desire to purchase. Preferably, the system will be configured to permit rapid upload of multiple part requests to facilitate ordering more than one part. The upload may be by transfer of information in an electronic file, such as a spreadsheet, data base, or other structured or unstructured file, or by any other means of transferring information from one computer system to another.

The system may search a new part inventory database for the part and a used part inventory database for a used part if a used part has been requested or a new part is not available in inventory. Alternately, the system may cue a human to review either the new part or used part inventory databases or both and provide information on part availability to the system.

If customer requests a new part and the system identifies a new part in inventory, the part may be offered to the customer at the asking price. Otherwise, if the system identifies a used part in inventory that meets the customer's criteria, the used part is offered to the customer. If desired, the system can offer both new and used parts that meet the customer's criteria. If the system identifies a used part in inventory that does not meet the customer's criteria, the system may determine if the characteristics of the part might be an alternative to the customer's stated criteria and offer the part to the customer if the part is determined to be an alternative to the part the customer requested. Alternately, the system may generate a request for a manual determination of whether the part might be an alternative to the part the customer requested. In either situation, a part may be determined to be an alternative to a requested part by reviewing the part's actual configuration and configuration management information that would identify wither the part is a potential alternative to the part the customer requested.

If the primary supplier is unable to offer a part in response to the customer's request or the customer has refused the primary supplier's offered part, the primary supplier can initiate a reverse auction among secondary suppliers (i.e., bidders) to obtain an acceptable part. Alternately, a reverse auction may be initiated independently of any other system is the primary supplier has a requirement that can be filled with a reverse auction. The reverse auction may be initiated automatically or manually. In a reverse auction, secondary suppliers that have the requested part bid against each other to sell the part to the primary supplier. The reverse auction may be operated over the Internet as in the illustrated embodiment (with information being transmitted between the parties in data signals embodied in an appropriate transmission medium) or through other links with suppliers. Preferably, the reverse auction will be initiated and completed within a short time after the inability to provide an acceptable part from the primary suppliers inventory, e.g., within forty-eight hours of receiving the customer's request for the part. In this manner, the reverse auction may be an invisible, seamless component of the primary supplier's response to the customer's request. The availability of parts from the reverse auction creates a “virtual” inventory for the primary supplier. In an alternate embodiment of the present invention, the primary supplier does not maintain an inventory of parts and obtains its parts through a reverse auction upon request.

In operating the reverse auction, bidders may be notified by email or another communication medium (e.g., text pager, cell phone, or any other suitable communication device) of the part requirements or criteria to be bid. At a set time, the bidders log on to the system as appropriate, for example by using a personal identification number (PIN), password, and/or other identifying credentials, review the requirements and prepare to bid when the reverse auction begins. In a preferred embodiment, reverse auctions are conducted regularly at a predetermined time, e.g., auction are held every business day from 12:00-2:00 p.m. At the initiation of the reverse auction, the primary suppler or system may enter the opening price as a target bid price. The target bid price is based on certain conditions and previous price history. Alternately, the opening bid may be entered by a bidder. The primary supplier or system may also set the minimum variation or increment required between bids based on a percentage of the estimated price and/or a fixed currency amount (e.g., a fixed dollar amount).

If the customer has requested a life limited part, the auction may be run on the basis of life units (e.g., cycles, hours, or other unit of life) remaining on the part. In such an auction, the customer may be required to state the minimum and maximum number of remaining life units acceptable. The bidders then would be required to state the number of life units remaining on the part or parts they are offering. The price being offered by the bidder may be stated either as price per remaining life unit or a total price for the part. If a total price for the part is entered, the system converts the total price for the part into a price per remaining life unit by dividing the total price for the part by the number of life units remaining on the part. The reverse auction itself is run only on the basis of price per remaining life unit and all comparisons are made based on this unit price. The total price offered for a life limited part is preferably not shown to the competing bidders, and the number of life units on a part being offered is preferably not shown to competing bidders. This approach protects this information, which could reveal potential competitive knowledge to others and removes any advantage one bidder may have over other bidders from knowing the number of remaining life units on competitor parts, both for the current reverse auction and any future selling of the parts by any method.

Conditions of the auction require that the bidder has the part available for sale and agrees to sell at its bid price. If a bidder cannot produce the part that meets its bid price and conditions, the bidder may be disqualified from future auctions. The bidders are apprised that a buy/order may not be placed for the lowest bid part but that there is a need for the requested part and there is the bona fide intention to make a purchase only if all conditions are met.

A bidder may enter bids as often as it wishes but each bid must be lower than its last bid by at least the minimum bid increment allowed. A bidder has several options for entering a bid. In one option, the bidder may enter a price and state the part conditions and that the conditions meet the requested requirements or criteria. If a lower price (i.e., bid) has been entered that meets or exceeds the requested criteria, the bidder will see the posting of the lower bid and will have the opportunity to rebid at a lower price.

A bidder's access to the bid of another supplier is limited. Each bidder will only see the bid from the next lowest bidder and must in turn bid lower in order to see the entry of any additional lower bidder. This limited access to bids will prevent a bidder from entering one high bid to determine selling prices for the requested part without having actually made a valid offer.

Initially the bidder may also enter a proxy bid by entering an opening price and a minimum price. The system will rebid automatically for the bidder and enter lower bids by the established incremental amount until the bidder's minimum price is reached. This type of bid entry and automatic rebid will allow the bidder to log off from the auction yet still maintain a bidding presence. When the minimum price is reached, the bidder will be notified by e-mail or any other communication medium and will be given the opportunity to re-enter the auction and make additional bids.

The auction may be run for a predetermined period. As can be appreciated, such an on-line reverse auction affords real time competitive market pricing of the particular part. If acceptable parts are bid, the “best fit” to the customer's request with the lowest bid price is offered to the customer at an asking price. The customer is shown the pedigree of the part (e.g., the criteria requested by the customer), maintenance release document and other necessary documentation as may be requested such as on/off logs, flight records, and overhaul history of the engine. If the customer accepts the price and part, the customer enters an order and the order is filled.

If the customer accepts the pedigree but wishes to negotiate price, the system may be configured to accept a price offer from the customer provided the customer agrees to buy the part at its offer price (i.e., the customer must enter a conditional order into the system). If the customer's price offer is higher than the lowest system price, the system will accept the offer, execute the conditional order and initiate the delivery of the part.

In an alternate embodiment, the customer can request a part and identify acceptable alternate parts. After it has been determined that the requested part or alternate parts are not available in inventory, the reverse auction may be configured to allow bidders to offer either the requested part or any acceptable alternate parts and the system will play the different parts against each other by treating all the parts as if they were the same part number for purposes of the auction.

In another alternate embodiment, the reverse auction allows for a chat session between a bidder and primary supplier or customer to provide direct communication to facilitate selection of a best fit part, clarify some aspect of a bid or supporting document, or for any other purpose. In a web environment, the chat session may be configured as real time text or verbal communications over the internet using any of the commercially available tools for such a session. Alternately, the chat session may be configured as an exchange of e-mail or other electronic communications outside of a web environment.

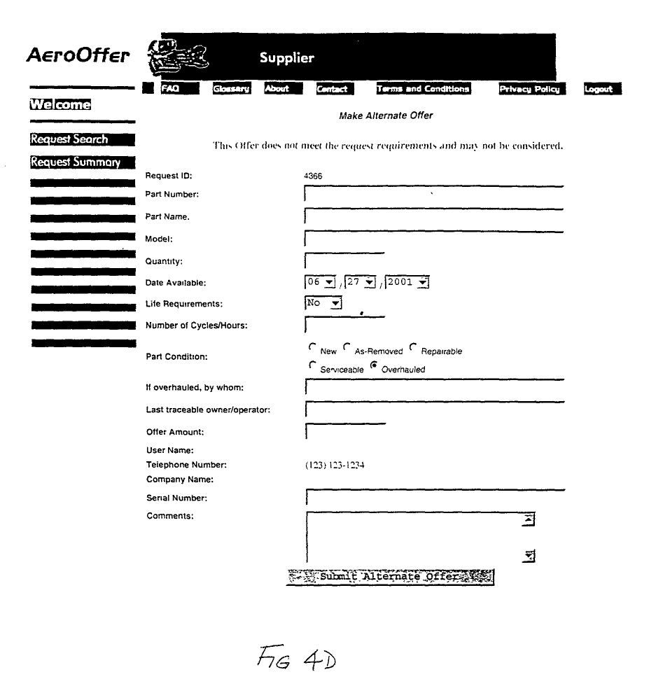

The method of the present invention is preferably implemented in software for execution on general purpose computers such as the type illustrated in FIG. 5. The program code may be written in a variety of programming languages (such as HTML, XML, JAVA, C++, etc.) to execute on the computer processor 14 within the computer 12. One application program that may be suitable is BidRocket! (available from Path Communications, Inc., Marina Del Rey, Calif.). Other applications programs that may be suitable for all or part of the system include, BusinessManager™ Suite (available from SpaceWorks, Inc., Rockville, Md.), MarketMaker™ (available from BroadVision, Inc., Redwood City, Calif.), and applications from other software vendors. The computer may also contain a memory 13 for storing program code and calculated data, a visual display screen 15 for displaying various information, keyboard 16 and mouse 17 that both used to input information to the processor and memory and a connection 18 for access to the Internet. These various devices are connected by a bus 19. Alternately, the method of the present invention may be implemented on any communications device capable of receiving, transmitting, and displaying information related to the method, such as web-enabled cellular telephones, two-way pagers, personal data assistants, and other wireless or wired communications devices known in the art or later developed.

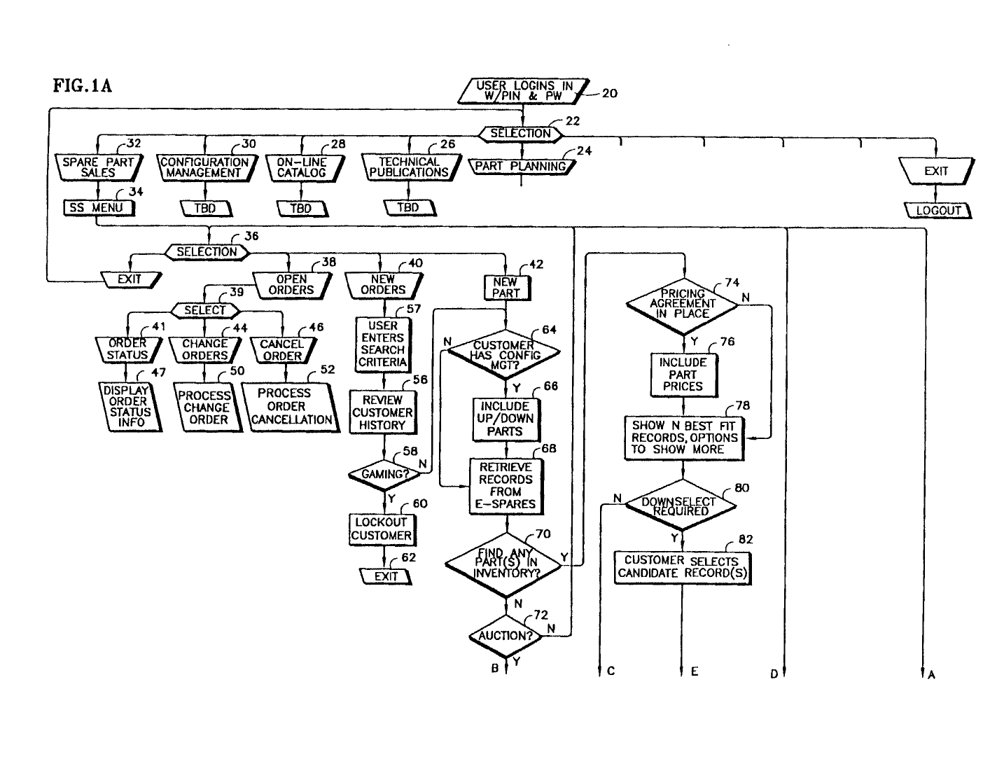

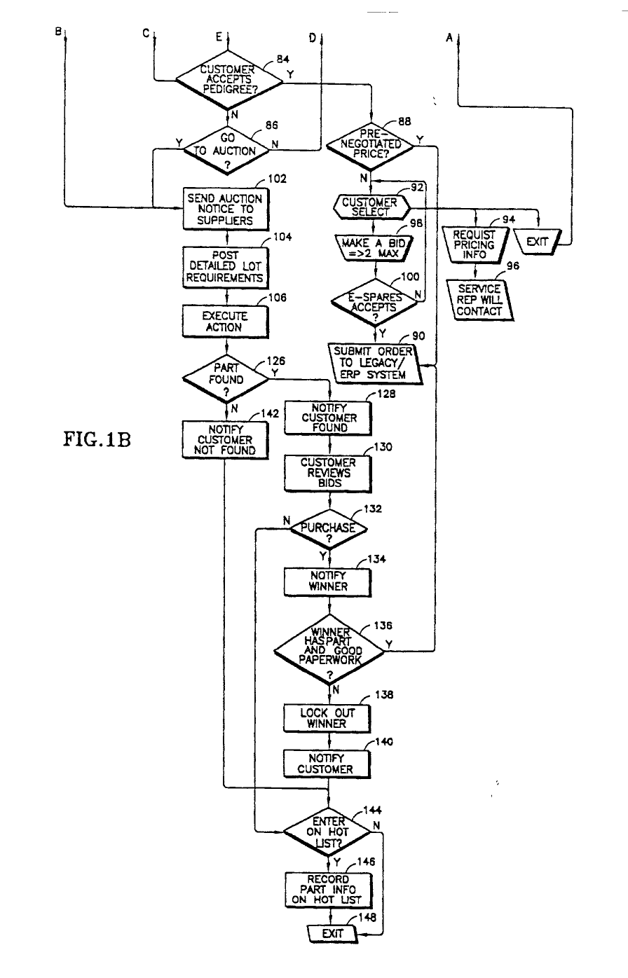

FIG. 1 is a flowchart of steps performed in an exemplary embodiment of a software program for employing the method of the present invention for marketing engine components. In the entry step 20, the customer connects to the web page of the primary supplier and logs in with a password (pw), personal identification number (pin), and/or any other suitable identification credentials. In one embodiment, the customer is presented with a selection step 22 of related online services such as part planning 24, technical publications 26, an online catalog 28, configuration management 30 and spare part sales 32. One skilled in the art will appreciate that the customer could be presented with any number of service offerings or only a single service offering such as spare part sales 32 or reverse auction 72.

The customer selects the spare parts sales service 32 and is presented at 34 with a serviceable sales (ss) menu, which is the menu for new and used engine parts. At step 36 the customer selects whether to inquire about an open order at 38, place a new order for a used part at 40 or place an order for a new part at 42. In an alternate embodiment, the customer could enter an order for either a used part or a new part in a single step. Under the open orders selection, the customer may select at step 39 whether to inquire about the status of an existing order at 41, change an existing order at 44 or cancel an order at 46. Selection of order status 41 provides the customer with a display of order status information 47 such as shipping data, a link to track shipments, etc. Selection of change order 44 presents a screen for processing a change order at 50 such as reducing the number of parts in an order. The cancel order 46 selection presents a screen for processing an order cancellation at 52.

Upon selection of the new order selection 40 for placing an order for a used part, at step 57 the customer enters information on the part requested including the part number and any requirements or criteria such as life units (e.g., time, cycles, or other life unit) values, trace requirements, overhauler limitations, etc.

At step 56 the system reviews the customer's history, if any, for information such as does this customer require overhaul parts from a specific supplier, did the customer ask for the same part recently, etc. At step 58 the order is reviewed for “gaming.” Gaming refers to activity where a customer may make several orders for the same part on various days to see if the price changes or for other nonproductive reasons. If it is determined that the customer is gaming, the order may be locked out at step 60 or the customer may be informed that it recently received information on the same part and this customer exits the system at step 62.

Upon determination that the customer is not gaming, the system queries a database at step 64 to determine if the customer has a configuration management agreement with the primary supplier. If so, at step 66 the system retrieves configuration management information on the requested part and provides it to the customer. Such information is generally technical information and may include the history of the part, whether the part is superseded or superseding (i.e., up/down part information), whether certain service bulletins apply to the part, etc. In aircraft engines, if a part is interchangeable, the interchangeable part may require a change to other material in the engine such as for example, a new set of bolts to go with the part. Configuration management information may also be very helpful in locating a used part. For example, the customer may be looking for part X and they are unable to find it so they are stymied. However, if part Y will interchangeably perform the same function, that information would be helpful so the customer may also search for part Y.

At step 68, the inventory records are retrieved from the database and are searched at step 70 to identify the requested part. The system may also use the configuration management data to search for interchangeable parts and for other parts that may be needed for installation so that those parts may also be offered to the customer.

If a part is not identified in inventory, a reverse auction is initiated at step 72. If a part is found in inventory, an agreement database is searched at step 74 to determine if a pricing agreement exists with the customer. If a pricing agreement is found, the pricing information is included with the part information at step 76. Pricing agreements concerning used parts are common and the price may be determined, for example, based upon a certain percentage of the current list price for the part.

At step 78 parts that best fit the customer's requirements are identified and information about the records on the parts are also provided together with a price if a pricing agreement applies. Alternately, if a pricing agreement does not apply, an asking price may be identified at this time. At step 80, the customer may elect to “down select” and consider other parts in the supplier's inventory at step 82 and obtain information on the records of these parts. In the event no down select is required or the customer has selected another part to review, at step 84 the customer decides whether or not to accept the stated pedigree of the proposed part. If the pedigree is not accepted, the customer can elect at step 86 for the supplier to seek to find the part (i.e., a reverse auction) or select a search for a new part through steps 36 and 42.

If the customer accepts the pedigree of the part, the system determines at step 88 whether there is a pre-negotiated price. If there is a pre-negotiated price, a purchase order is initiated at step 90 such as through an enterprise resource planning system or any other automatic or manual system. If there is no pre-negotiated price or no stated price accepted by the customer, the customer may select at step 92 to request pricing information at step 94 which will initiate at step 96 a request for a service representative to contact the customer directly or through a chat session as previously described. Alternately, the customer may elect to make an offer for the part at step 98 which the system may accept or reject at step 100. If the offer is accepted, the system will initiate a purchase order according to step 90.

In the event the requested part is not found in inventory, the system will go to reverse auction at step 72 and in the event the customer does not accept any part(s) found in inventory, the system will initiate a reverse auction at step 86. The reverse auction is initiated by the primary supplier sending an notice to secondary suppliers at step 102 by e-mail or another communication medium notifying them of the reverse auction and part requirements. At step 104, the detailed requirements of the part request are posted on the primary supplier's web page or other communications link for review by the secondary suppliers.

At a predetermined time, the bidders log on to the primary supplier's web page with a personal identification number, password, and/or other identification credentials. The bidders review the requirements and prepare to bid when the reverse auction begins. At the initiation of the reverse auction at step 106, an opening price is presented as a target bid to the bidders.

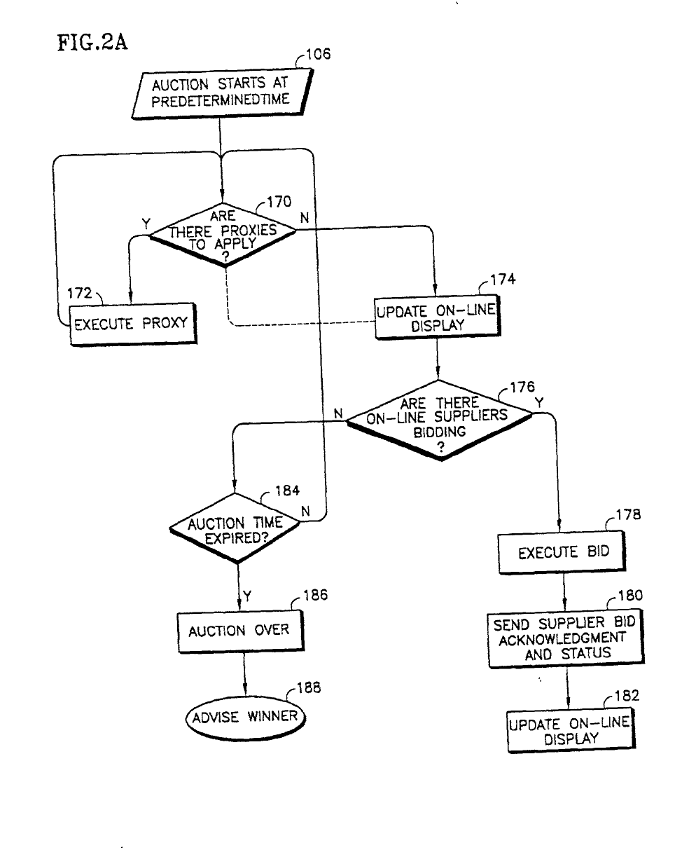

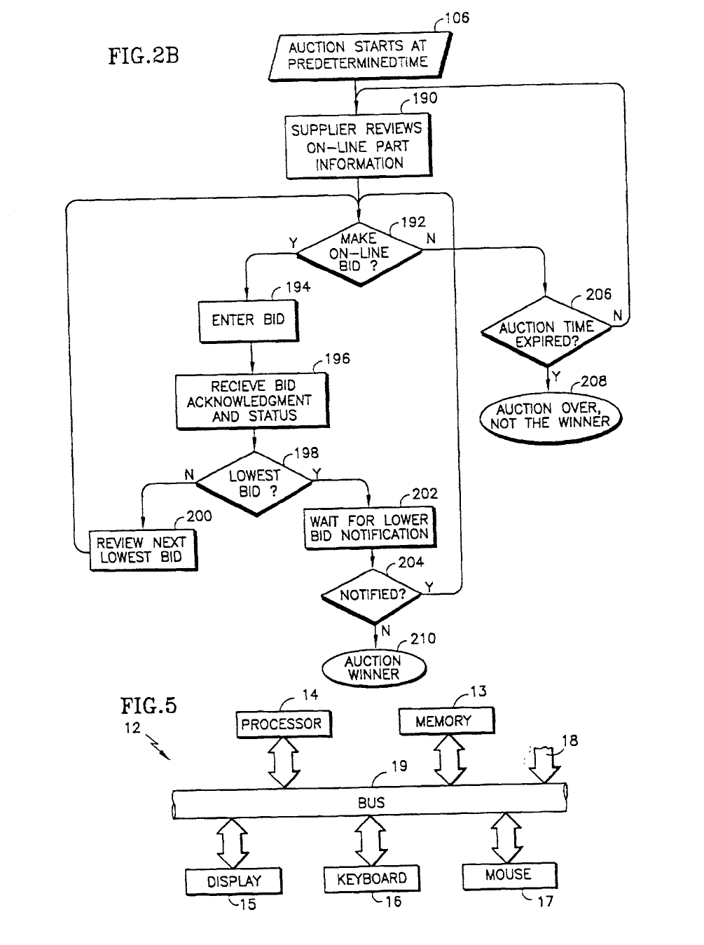

Referring to FIG. 2A, the reverse auction may be executed as follows. The reverse auction is initiated at a predetermined time at 106 with a target bid price. If the part being sought is a life limited part, the target bid price may be either a price per life unit or price for the part. If the part being sought is not a life limited part, the target price will be a price for the part. The system determines at 170 whether there are any bid proxies for the requested part. (A proxy bid is a form of bid where the bidder does not have to participate online. The primary bidder enters an opening price and a minimum price and the system will rebid automatically for the proxy bidder and enter lower bids by the established incremental amount until the proxy bidder's minimum price is reached.) If an applicable proxy bid is available, the proxy bid is executed at 172 and the bid is entered in the auction and the system again determines whether there are any other proxies to apply. If there are a number of proxies, the system determines the bid to be entered by a determination analogous to a mini-auction between the proxy bids. If the part being sought is a life limited part being bid on a price per life unit basis and the proxy bid is entered as a price for the part, the system will convert the proxy bid to a price per life unit by dividing the price for the part by the remaining life units on the part.

If there are no further proxy bids available at 170, the system updates online display information at 174 to accommodate the proxy bid or the initial target bid price and determines whether there are online bidders at 176. Online display information as updated at 174 is available for personnel overseeing the reverse auction.

If there are online bidders, the system enters the bid at 178 and at step 180 displays an acknowledgment screen to the respective bidder with bid status information. If the part being sought is a life limited part being bid on a price per life unit basis and the online bid is entered as a price for the part, the system will convert the online bid to a price per life unit by dividing the price for the part by the remaining life units on the part. The system updates online display information at 182 and then determines again at 170 whether there are any applicable proxy bids. As the bidding process continues between the online bidders and any proxy bidders, the system repeats the sequences of steps of (i)170, 172 and (ii)174-182.

Referring to FIG. 2B, after the reverse auction is initiated at 106, the supplier may review online at 190 information on the requested component and criteria. At 192 the supplier selects whether to make an online bid. If the supplier selects to make a bid, the supplier enters the bid at 194. The system determines at 176 (FIG. 2A) that there is an online bidder and executes the bid at 178. If the part being sought is a life limited part being bid on a price per life unit basis and the online bid is entered as a price for the part, the system will convert the online bid to a price per life unit by dividing the price for the part by the remaining life units on the part. At 196, the bidder receives a bid acknowledgment and bid status display. The system determines whether the bid is the lowest bid at 198 and, if not, the bidder reviews the next lowest bid at 200 and selects whether to make another online bid at 192. If the bid is determined to be the lowest bid at 198, the bidder's activity is paused at 202 as long as it is the lowest bid while the system cycles through the sequence of stages for proxy bids and/or other online bidders.

If the bidder is not eventually notified of a next lowest bidder, the bidder will be the winner at 210. If the bidder is notified at 204 of a next lowest bid, the bidder again selects at 192 whether to make another online bid. If the bidder elects to make another bid, the sequence recycles through steps 194-202 beginning with the entry of the bid at 194. If the bidder elects to not make a further bid, the system determines at 206 whether the auction time has expired. If the auction time has expired, the system determines at 208 that the auction is over and this particular bidder is not the winner. If the auction time has not expired, the bidder is returned at 190 to the online information display for the requested component.

Referring back to FIG. 2A, if there are no online suppliers bidding, the system determines at 184 whether the time period of the auction has expired. If the time period has not expired, the system queries whether there are any applicable proxy bids at 170 and repeats the sequences previously described. If the time period has expired, the auction is terminated at 186 and winning bidder, if any, is notified at 188.

For purposes of explanation, an example bidding sequence for a part that is not a life limited part is set forth below among bidders A, B, C & D where a part has been requested with certain criteria (e.g., it must be overhauled and have specified trace information) and the initial target price is $115.

| | |
|---|---|
| Bidder A enters a bid | Bidder A is acknowledged and thanked. |
| for $110.00 | |
| Bidder B enters a bid | Bidder B is acknowledged and thanked. |
| of $105.00 | Bidder A sees a notice that they have been |
| | underbid and that the next lowest bid is |
| | $105.00. |
| Bidder C enters a bid | Bidder C is acknowledged and thanked. |
| of $100.00 | Bidder B sees a notice that they have been |
| | underbid and that the next lowest bid is |
| | $100.00. |
| Bidder D enters a bid | Bidder D is acknowledge and thanked. |
| of $95.00 | Bidder C sees a notice that they have been |
| | underbid and that the next lowest bid is |
| | $95.00. |
| Bidder A enters a new bid | Bidder A is acknowledged and sees a |
| of $103.00 | notice that the next lowest bid is $100.00. |
| Bidder A enters a new bid | Bidder A is acknowledged and sees a |
| of $97.00 | notice that the next lowest bid is $95.00. |
| Bidder C enters a new bid | Bidder C is acknowledged and thanked. |
| of $90.00 | Bidder D sees a notice that they have been |
| | underbid and that the next lowest bid is |
| | $90.00. |
| No additional bids are | Bidder C has the most likely “best fit” and |
| accepted. | is asked to submit documentation. |

For purposes of explanation, an example bidding sequence for a life limited part is set forth below among bidders A, B, C & D where a part has been requested with certain criteria (e.g., it must be overhauled and have specified trace information), including a price per remaining cycle, and the initial target price is $2.20 per cycle.

| | |
|---|---|
| Bidder A enters a bid of | Bidder A is acknowledged and thanked. |
| $11,000.00 for a part with | The system converts the bid to $2.20 per |
| 5000 cycles remaining | cycle by dividing $11,000 by 5000 cycles. |
| Bidder B enters a bid of | Bidder B is acknowledged and thanked. |
| $12,000.00 for a part with | The system converts the bid to $2.00 per |
| 6000 cycles | cycle by dividing $12,000 by 6000 cycles. |
| | Bidder A sees a notice that they have been |
| | underbid and that the next lowest bid is |
| | $2.00 per cycle. |
| Bidder C enters a bid of | Bidder C is acknowledged and thanked. |
| $1.95 per cycle | Bidder B sees a notice that they have been |
| | underbid and that the next lowest bid is |
| | $1.95 per cycle. |
| Bidder D enters a bid of | Bidder D is acknowledge and thanked. |
| $1.90 per cycle | Bidder C sees a notice that they have been |
| | underbid and that the next lowest bid is |
| | $1.90. |
| Bidder A enters a new bid of | Bidder A is acknowledged and thanked. |
| $9900.00 for a part with 5000 | The system converts the bid to $1.98 per |
| cycles remaining. | cycle by dividing $9900 by 5000 cycles. |
| | Bidder A sees a notice that the next lowest |
| | bid is $1.95 per cycle. |
| Bidder A enters a new bid of | Bidder A is acknowledged and thanked. |
| $9700.00 for a part with 5000 | The system converts the bid to $1.94 per |
| cycles remaining. | cycle by dividing $9700 by 5000 cycles. |
| | Bidder A sees a notice that the next lowest |
| | bid is $1.90 per cycle. |
| Bidder C enters a new bid of | Bidder C is acknowledged and thanked. |
| $1.85 per cycle | Bidder D sees a notice that they have been |
| | underbid and that the next lowest bid is |
| | $1.85 per cycle. |
| No additional bids are | Bidder C has the most likely “best fit” and |
| accepted. | is asked to submit documentation. |

Returning to FIG. 1, at step 126 the system determines whether the requested part is available from the secondary suppliers. If the requested part is available, the customer is notified at step 128. At step 130, the customer reviews the part information for the part which represents the “best fit” to the part requirements. The customer also has the ability to look at other parts that were offered during the action if desired.

The decision whether to purchase the part is made at step 132 and the secondary supplier which bid that particular part (i.e., the winning bidder) is notified at step 134 that part is selected.

At step 136 the system confirms that the secondary supplier has the part and appropriate documentation to substantiate the customer's requirements. Preferably, the supplier scans the documentation into electronic form. The winning bidder sends the supporting documentation to a repository maintained by the primary supplier and the customer is granted access to view the documentation online. If the winning bidder does not have the part or the required documentation, the winning bidder may be locked out from future auctions at step 138 and the customer is notified at step 140. The customer may consider other bids reviewed at step 130 and repeat steps 132-136. If the winning secondary supplier has the part and appropriate documentation at step 136, a purchase order is initiated according to step 90.

In the event the requested part is not found as a result of the reverse auction, the customer is notified at step 142. In such event or in the event the part that is found is rejected by the customer at step 132 or it is determined at step 136 that the secondary supplier does not have the part or proper documentation, the system will decide whether to place the requested part on a so called “hot list” at step 144 to be used for subsequent searches or later auctions. At this point the customer exits the web site at step 148. In the event the customer elects not to enter the requested part on the hot list at step 144, the customer then exists the web site at step 148.

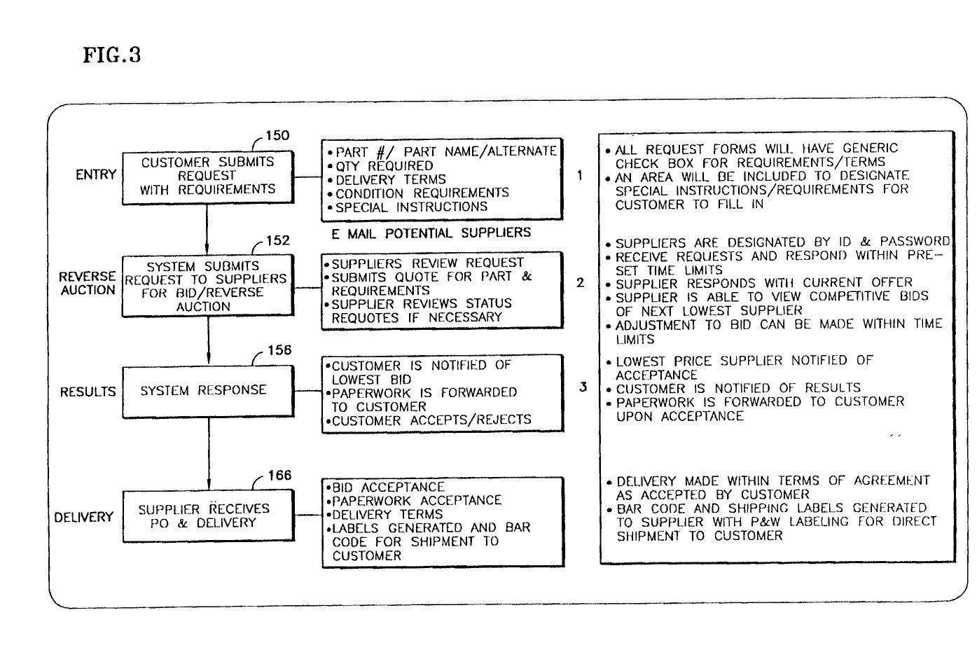

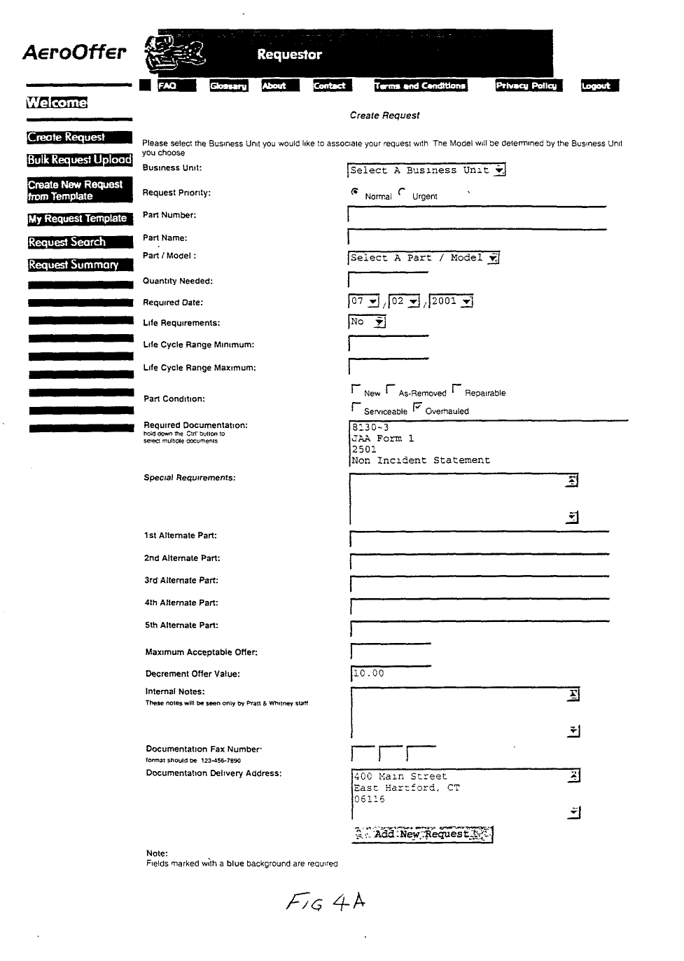

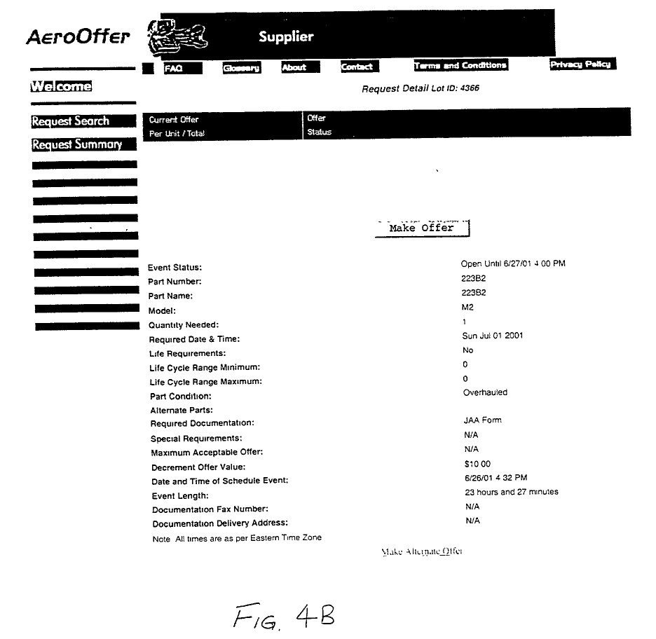

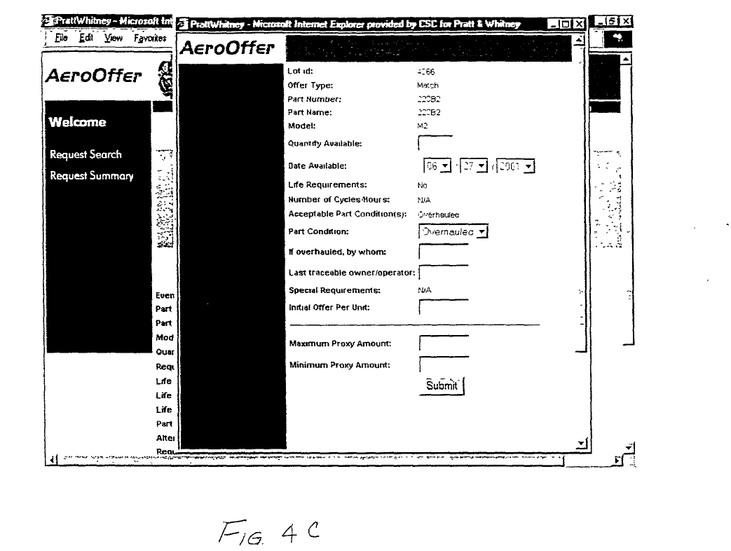

Referring to the flowchart of FIG. 3 which shows a selected sequence in a method according to the present invention, at 150 the customer electronically submits a request for an engine part with specified part requirements. A graphical user interface (GUI) (entitled “Create Request”) for submitting a part request is shown in FIG. 4A for purposes of explanation and provides for the customer's entry of part number, part name, quantity required, delivery terms, part condition requirements and an area for special requirements.

If a reverse auction is to be conducted at 152, the system submits a request or notice to secondary suppliers for a reverse auction. The secondary suppliers are provided with the part requirements. The suppliers review the requirements and respond within preset time limits. The process is iterative in that the supplier responds with a current offer and is able to view competitive bids of the next lowest supplier and upon review may requote and make adjustments to its bid within time limits. FIG. 4B (entitled “Request Detail”) and a pop-up date entry window shown in FIG. 4C illustrate representative GUIs for this iterative process. The response provides for a current offering bid and an optional minimum bid from the supplier as well as information on the condition of the offered part. If the supplier is unable to meet the requirements, it may offer an alternative part with time/cycle information. The bidder is informed of the next lowest bid to the current bid identified and may select additional information on the competitors' responses at 154. FIG. 4D shows a window in which the supplier may make an alternate bid if its current bid is not the current lowest bid.

The system response to the results of the reverse auction at 156 (FIG. 3) is to notify the customer of the lowest bid. The customer is provided with the lowest bid and information on the requirements of the part. If the part does not meet the customer's requirements, there is a provision for offering an alternative part with information on the condition of the part. The customer may select to review documentation on this part at 158 or it may accept the part at 160 and request entry of a purchase order and shipment of the parts. The customer may alternatively select to discontinue the part request at 162 and request contact by the primary supplier for additional information at 164. It is understood that a wide variety of GUI's may be utilized at the numerous interactive steps of the process of FIG. 1.

Upon acceptance of the part, the supplier receives a purchase order and delivery instructions at 166 (FIG. 3). Delivery of the part is effected and, in the illustrated, embodiment labels are generated for direct shipment to the customer from the secondary supplier with the primary supplier's labeling.

As can be appreciated from the foregoing, a new and improved computerized method and system for marketing aircraft engine components has been described. Although the method and system described has particular utility in the marketing of aircraft engine parts, it can be appreciated that this method and system may be utilized in the marketing of other types of components and items in an online environment or otherwise.

The foregoing described method and system allows for expeditious and efficient procurement of used components with selective availability of real time competitive market pricing through the reverse auction capability. From the customer's prospective, it provides a single source for new and used parts that offers an increased expectation of meeting part procurement requirements in an efficient manner. From the primary supplier's perspective, it affords the supplier an increased inventory availability without a commensurate increase in inventory carrying costs (i.e., a virtual inventory).

As will be apparent to persons skilled in the art, various modifications and adaptations of the above-described method and system may be made without departure from the spirit and scope of the invention, the scope of which is defined in the appended claims.

We claim:

1. A computerized method for marketing components or services comprising the steps of:
(a) receiving a request for a requested component or service from a customer with criteria information for the component or service;
(b) determining whether the requested component or service is available to be provided to the customer;
(c) if the requested component or service is available to be provided to the customer, offering the requested component or service to the customer;
(d) if the requested component or service is not available to be provided to the customer, conducting a reverse auction for the requested component or service among a plurality of suppliers;
(e) receiving bids from two or more suppliers that offer to sell an offered component or service in response to the request for the requested component or service;
(f) comparing criteria information for each offered component or service with criteria information for the requested component or service to determine if the offered component or service approximately meets criteria information for the requested component or service;
(g) if one or more offered component or service approximately meets criteria information for the requested component or service, selecting which offered component or service to offer to the customer; and
(h) offering the selected offered fit component or service to the customer.

2. The method of claim 1, wherein one or more of steps (a), (c), (d), (e), and (h) is executed on a web-based system.

3. The method of claim 1, wherein step (e) further comprises receiving a proxy bid for a proposed sale of a requested component or service with an opening price and a minimum price to allow automatic successive rebidding by an established incremental amount until reaching said minimum price or the supplier wins the reverse auction.

4. A computerized method for marketing components or services comprising the steps of:
(a) receiving a request for a requested component or service from a customer;
(b) determining whether the requested component or service is available to be provided to the customer;
(c) if the requested component or service is available to be provided to the customer, offering the requested component or service to the customer;
(d) if the requested component or service is not available to be provided to the customer, conducting a reverse auction for the requested component or service among a plurality of suppliers;
(e) notifying a plurality of suppliers of a desire to purchase a requested component or service and a target bid for the requested component or service;
(f) receiving and reviewing a first supplier bid to sell an offered component or service in response to the request for the requested component or service;
(g) if the first supplier bid is lower than the target bid, establishing the first supplier bid as the lowest bid;
(h) receiving and reviewing an additional supplier bid to sell another offered component or service;
(h1) if the additional supplier bid is lower than the lowest bid, updating the lowest bid to equal the additional supplier bid and notifying the supplier that made the previous lowest bid of the new lowest bid;
(h2) if the additional supplier bid is higher than the lowest bid but lower than another supplier bid previously received, notifying the supplier that made the supplier bid that is immediately higher than the additional supplier bid of the additional supplier bid; and
(i) repeating step (h) and substeps (h1) and (h2) until there are no additional supplier bids to review.

5. The method of claim 4, further comprising the steps of:
(j) comparing information about the winning supplier's offered component to information about the requested component to determine whether the winning supplier's offered component is acceptable; and
(k) if the winning supplier's offered component is acceptable, purchasing the winning supplier's offered component.

6. The method of claim 4, wherein one or more of the steps is executed on a web-based system.

7. The method of claim 4, wherein the additional supplier bid of steps (h), (h1), (h2), and (l) comprises a proxy bid for a proposed sale of a requested component or service with an opening price and a minimum price to allow automatic successive rebidding by an established incremental amount until reaching the minimum price or the additional supplier wins the reverse auction.

8. A computerized method for marketing life-limited components comprising the steps of:
(a) receiving a request for a requested life-limited component from a customer with criteria information for the component, including a minimum number of life units remaining on the component;
(b) searching component inventory information to determine whether the requested component is available from an inventory;
(c) if the requested component is available from an inventory, offering the requested component to the customer; and
(d) if the requested component is not available from an inventory, conducting a reverse auction for the requested component among a plurality of suppliers.

9. The method of claim 8, wherein the criteria information for the component also include a maximum number of life units remaining on the component.

10. The method of claim 8, wherein the life units are selected from the group consisting of cycles and hours.

11. The method of claim 8, wherein one or more of the steps is executed on a web-based system.

12. The method of claim 8, wherein step (d) further comprises:
(d1) notifying the plurality of suppliers of a request for the requested component with the criteria information;
(d2) receiving a bid for a proposed sale of a bid component from a supplier; and
(d3) determining whether to offer a bid component for sale to the customer.

13. The method of claim 12, wherein one or more of the steps is executed on a web-based system.

14. The method of claim 12, wherein the bid comprises a full price for the bid component and the number of life units remaining on the bid component and step (d2) further comprises dividing the full price for the bid component by the number of life units remaining on the bid component to determine a price per remaining life cycle for the bid component.

15. The method of claim 12, wherein step (d3) further comprises comparing criteria information for a bid component to criteria information for the requested component to determine if the bid component approximately meets the criteria information for the requested component.

16. The method of claim 12 further comprising:
(d4) providing the customer access to documents substantiating the criteria information of the bid component.

17. The method of claim 16, wherein access is provided by an Internet connection to electronic copies of said documents.

18. The method of claim 8, wherein step (d) further comprises:
(d1) notifying the plurality of suppliers a request for the requested component and a target bid for the requested component;
(d2) receiving and reviewing a first bid for a proposed sale of a bid component from a supplier;
(d3) if said the bid is lower than the target bid, establishing the first bid as the lowest bid;
(d4) receiving and reviewing an additional bid for a proposed sale of another bid component from another supplier;
(d5) if the additional bid is lower than the lowest bid, updating the lowest bid to equal the additional bid and notifying the supplier that made the previous lowest bid of the new lowest bid;
(d6) if the additional bid is higher than the lowest bid but lower than another bid previously received, notifying the supplier that made the bid that is immediately higher than the additional bid of the additional bid; and
(d7) repeating the steps (d4)-(d6) until there are no additional bids to review.

19. The method of claim 18, wherein the first bid comprises a full price for the bid component and the number of life units remaining on the bid component and step (d2) further comprises dividing the full price for the bid component by the number of life units remaining on the bid component to determine a price per remaining life cycle for the bid component.

20. The method of claim 18, wherein the additional bid comprises a full price for the bid component and the number of life units remaining on the bid component and step (d4) further comprises dividing the full price for the bid component by the number of life units remaining on the bid component to determine a price per remaining life cycle for the bid component.

21. The method of claim 18, wherein the additional supplier bid of step (d5), (d6), and (d7) comprises a proxy bid for a proposed sale of a bid component with an opening price and a minimum price to allow automatic successive rebidding by an established incremental amount until reaching the minimum price or the additional supplier wins the reverse auction.

22. A computerized method for marketing used, life-limited aircraft engine components for execution on a web-based system with Internet connections to customers and suppliers, comprising the steps of:
(a) receiving from a customer a request for a requested used, life-limited aircraft engine component having identified requirements of overhaul condition, trace information, and minimum number of life units remaining on the component;
(b) conducting a reverse auction for the requested component among a plurality of suppliers by:
(b1) notifying the plurality of suppliers of a request for the requested component with the identified requirements;
(b2) receiving a plurality of bids for a proposed sale of a bid component from suppliers with criteria information of overhaul condition, trace information, number of life units remaining on the component; and
(b3) determining whether to offer a bid component for sale to the customer; and
(c) notifying the customer of availability of a bid component.

23. The method of claim 22, wherein the criteria information also include a maximum number of life units remaining on the component.

24. The method of claim 22, wherein the life units are selected from the group consisting of cycles and hours.

25. The method of claim 22, wherein one or more of the bids comprises a full price for the bid component and the number of life units remaining on the bid component and step (b3) further comprises dividing the full price for the bid component by the number of life units remaining on the bid component to determine a price per remaining life cycle for the bid component.

26. The method of claim 22, wherein step (b3) further comprises comparing a bid component and its overhaul condition, trace information, and minimum number of life units remaining to the requested component with identified requirements of overhaul condition, trace information, and minimum number of life units remaining to determine if the bid component approximately meets the identified requirements.

27. The method of claim 26, further comprising selecting a bid component with an overhaul condition, trace information, and minimum number of life units remaining that represents a best-fit to the requested component.

28. A sequence of computer data signals in executing a computerized method for marketing life-limited components comprising:
(a) a first data signal embodied in a transmission medium from a customer to a primary supplier identifying a requested component with identified criteria, including a minimum number of life units remaining on the component;
(b) a second data signal embodied in a transmission medium from a primary supplier to a plurality of secondary suppliers identifying the requested component with the identified criteria in the first data signal; and
(c) a third data signal embodied in a transmission medium from one of the plurality of secondary suppliers to the primary supplier identifying a bid for a proposed sale of a bid component with component criteria, wherein the third data signal is responsive to the requested component in second data signal.

29. The sequence of computer data signals of claim 28 wherein the requested component is an aircraft engine component.

30. The sequence of computer data signals of claim 28 wherein the third data signal identifies a bid comprising a full price for the bid component and the number of life units remaining on the bid component.

31. The sequence of computer data signals of claim 28, further comprising a fourth data signal that identifies the quotient of the full price for the bid component divided by the number of life units remaining on the bid component.

32. The sequence of computer data signals of claim 28 wherein the third data signal identifies a proxy bid for a proposed sale of a bid component with an opening price and a minimum price.

33. The sequence of computer data signals of claim 28 comprising a fourth data signal embodied in a transmission medium from the primary supplier to said one of the plurality of secondary suppliers with status information on the bid for a proposed sale of a bid component.

34. The sequence of computer data signals of claim 28 comprising a fourth data signal embodied in a transmission medium from the primary supplier to the customer identifying a bid component with component criteria.

35. The sequence of computer data signals of claim 28 comprising a fifth data signal embodied in a transmission medium from the primary supplier to the one of the plurality of secondary suppliers with acceptance information on the bid for a bid component.
